(19) United States
(12) Patent Application Publication
(10) Pub. No.: US 2023/0333900 A1
(43) Pub. Date: Oct. 19, 2023

(54) FRIENDLY CUCKOO HASHING SCHEME FOR ACCELERATOR CLUSTER LOAD BALANCING

(71) Applicant: Groq, Inc., Mountain View, CA (US)

(72) Inventor: Jonathan Alexander Ross, Palo Alto, CA (US)

(21) Appl. No.: 18/300,057

(22) Filed: Apr. 13, 2023

Related U.S. Application Data
(60) Provisional application No. 63/331,164, filed on Apr. 14, 2022.

(51) Int. Cl. G06F 9/50

(52) U.S. Cl. CPC G06F 9/5033; G06F 9/505; G06F 9/5044

(57) ABSTRACT

Improved placement of workload requests in a hosted compute resource uses a ‘friendly’ cuckoo hash algorithm to assign each workload request to an appropriately configured compute resource. When a first workload request is received, the workload is assigned to the compute resource module that has been pre-configured to execute that workload. Subsequent requests for a similar workload are either assigned to a second pre-configured compute resource or queued behind the first workload request.

### RELATED APPLICATIONS

This application claims the benefit of priority to U.S. Provisional Application Ser. No. 63/331,164, filed on 2022 Apr. 14, and entitled “FRIENDLY CUCKOO HASHING SCHEME FOR ACCELERATOR CLUSTER LOAD BALANCING”

### COPYRIGHT NOTICE

This patent document can be exactly reproduced as it appears in the files of the United States Patent and Trademark Office, but the assignee(s) otherwise reserves all rights in any subsets of included original works of authorship in this document protected by 35 USC 102(a) of the US. copyright law.

### SPECIFICATION—DISCLAIMERS

In the following Background, Summary, and Detailed Description, paragraph headings are signifiers that do not limit the scope of an embodiment of a claimed invention (ECIN). The citation or identification of any publication signifies neither relevance nor use as prior art. A paragraph for which the font is all italicized signifies text that exists in one or more patent specifications filed by the assignee(s).

A writing enclosed in double quotes (“ ”) signifies an exact copy of a writing that has been expressed as a work of authorship. Signifiers, such as a word or a phrase enclosed in single quotes(”), signify a term that as of yet has not been defined and that has no meaning to

a. be evaluated for or has no meaning in that specific use (for example, when the quoted term ‘module’ is first used) until defined.

### TECHNICAL FIELD

The present disclosure generally relates to load balancing for a tensor streaming processor architecture deployed in a datacenter environment.

### BACKGROUND

### Simple Task, Multiple Processor, Load Balancing

Artificial Intelligence (AI) techniques are transforming the capabilities of every industry and driving innovation in emerging technologies such as robotics, IoT (Internet of Things), healthcare and automotive industries. The technology is enabled by specialized microprocessors, such as multi-core central processing units (CPUs), Graphics Processing Units (GPUs) and neural network accelerator processing units (NNAPUs). These engineering- enhanced microprocessors create complex problems to efficiently use their computational resources, especially when used in clusters where memory resources and processes must be assigned to, and transferred among, multiple processors.

Accelerator clusters are collections of high-performance computing devices that work together to solve complex computational problems. Load balancing is an important technique used in accelerator clusters to distribute workloads evenly across the available resources, ensuring that each device is utilized efficiently and that the overall cluster performance is optimized.

There are several approaches to load balancing in accelerator clusters, depending on the specific hardware and software configuration of the system. Here are some common techniques.

Round-robin scheduling: This method involves assigning each task to a different device in a cyclic order. For example, if there are four devices in the cluster and four tasks to be executed, each device would be assigned one task in a sequential manner. This method is simple to implement and ensures that all devices are utilized evenly, but it does not take into account the varying processing capabilities of the devices.

Dynamic load balancing: This method involves monitoring the performance of each device in real-time and assigning tasks to the device that is currently the least busy. This method can optimize the overall cluster performance by ensuring that tasks are assigned to the most capable devices, but it requires more sophisticated monitoring and scheduling algorithms.

Task partitioning: This method involves breaking up larger tasks into smaller sub-tasks that can be executed in parallel on multiple devices. The sub-tasks are assigned to devices based on their processing capabilities and availability, and the results are combined at the end to produce the final output. This method can be highly efficient for certain types of problems, but it requires careful partitioning of the tasks and coordination of the results.

Overall, load balancing is an essential technique for maximizing the performance and efficiency of accelerator clusters. By distributing workloads evenly across the available resources, load balancing can help ensure that each device is utilized to its fullest potential, resulting in faster and more efficient computation.

### Hashing

One process used for many engineering allocation problems that rely on arrays or tables for managing the allocation, is that of hashing. Hashing is a process for reducing a numerical value with a range wider than an associated table, to a numerical value with a smaller range that can be used as an index into the table. Hashing can also be used to convert a non-numerical value into a numerical index. For example, if one assigns the value of 1 to ‘a’ and so on until ‘z’ is reached with a value of 26, and want to create a hash value for a sentence, one method is to convert each letter in the sentence to its numerical value, and add the numerical values together (modulo some number to reduce the range), the result is a numerical hash value for that sentence.

One technique is to use hash tables to allocate the memory, for example, using dynamic cuckoo hash tables as seen in a 2021 paper, “DyCuckoo: dynamic hash tables on GPUs”, presented at the 2021 IEEE 37^{th} International Conference on Data Engineering.

A related approach is using an improved form of bucketized cuckoo hash tables (BCHT) called Horton tables to allocate memory, for example, as seen in a 2016 paper, “Horton tables: fast hash tables for in-memory data-intensive computing”, presented at the 2016 USENIX Annual Technical Conference.

Hash tables are important data structures that lie at the heart of important applications such as key-value stores and relational databases. Typically, bucketized cuckoo hash tables (BCHTs) are used because they provide high throughput lookups and load factors that exceed 95%. Unfortunately, this performance comes at the cost of reduced memory access efficiency. Positive lookups (key is in the table) and negative lookups (where it is not) on average access 1.5 and 2.0 buckets, respectively, which results in 50 to 100% more table-containing cache lines to be accessed than should be minimally necessary.

To reduce these surplus accesses, the Horton table was introduced. Horton table is, revamped BCHT that reduces the expected cost of positive and negative lookups to fewer than 1.18 and 1.06 buckets, respectively, while still achieving load factors of 95%. The key innovation is remap entries, small in-bucket records that allow (1) more elements to be hashed using a single, primary hash function, (2) items that overflow buckets to be tracked and rehashed with one of many alternate functions while maintaining a worst-case lookup cost of 2 buckets, and (3) shortening the vast majority of negative searches to 1 bucket access. With these advancements, Horton tables outperform BCHTs by 17% to 89%.

Thus, Horton tables are another extension of bucketized Cuckoo hash tables that distinguish between types A and B of buckets. While type A contains no extra information, buckets of type B include a remap entry that allows more items to be hashed with a single function. With this remap array all items that have overflown are kept track of. Maintaining a worse-case lookup of two buckets and reducing the majority of negative lookups to one more bucket access. On the contrary, insertion is more complex specifically if the primary bucket is full.

A similar engineering problem is efficiently assigning clusters of CPUs, acting as Web page servers, to process incoming requests for Web pages. Here again, cuckoo hashing can be used, as well as related assignment techniques such as Hopscotch maps. These uses are seen in a 2021 paper, “A comparison of multi-core flow classification methods for load balancing” of web page requests, a technical report from the KTH Royal Institute of Technology in Sweden.

More specifically, load balancers enable a high number of parallel requests to a web application by distributing the requests to multiple backend servers. Stateful load balancers keep track of the selected server for a request in the flow table. As the flow table is accessed for each packet, its implementation is crucial for the performance of the load balancer. The evaluation can be made by comparing three single-core implementations of flow tables in a load balancer, based on C++ unordered maps, Cuckoo hash maps, and Hopscotch hash maps.

Hopscotch is an algorithm that defines a neighborhood of size N and keeps the last location of the hashed key within its neighborhood. The location of that key can be moved inside that neighborhood to leave space for a more recent insertion by switching positions.

Referring again to dynamic cuckoo hash tables, more specifically, cuckoo-hashing is an engineering process for resolving hash collisions of values of hash functions in a table, with worst-case constant lookup time and an expected constant write time.

The name derives from the behavior of some species of the cuckoo bird, where a cuckoo chick pushes the other eggs or young out of the nest when it hatches; analogously, inserting a new key into a non-empty cell of a cuckoo hashing table pushes an older key to a different location in the table.

Cuckoo hashing uses the process of open addressing. With open addressing, a hash function is used to determine the cell (i.e., the location) for each key or key-value pair, and the presence of the key in the table (or the value associated with it) is found by examining that cell of the table.

However, open addressing suffers from collisions, which happens when more than one key is mapped to the same cell.

The simple version of cuckoo hashing resolves collisions by using two hash functions instead of one. This provides two possible locations in the hash table for each key. In one of the commonly used variants of the algorithm, the hash table is split into two smaller tables of similar size, and each hash function provides an index into one of these two tables, where whichever indexed cell in either table is free, is used to store the key. It is also possible for both hash functions to provide indexes into a single table.

These processes are ‘simple’ in that the execution time is not excessive and often is predictable, for example, retrieving a Web page from a server database and sending it to a client browser (time allocation). Memory allocation (space allocation) calculations are also not that complicated, in that they only need to find space in some memory buffer indexed by a (linked) list of pointers, and then assign an incoming memory request to that space and pass back pointers to the memory space (the key value).

### Complex Task Multiple Processor Load Balancing

What is a much more complicated problem is the balancing of highly compute-intensive processes to multiple CPUs or NNAPUs modules (comprising the processing and supporting circuitry), which requires allocating both space (memory for the instructions and data) and time (time for the processors to execute all of the instructions), where the memory can be in the gigabytes and the processing throughput can be in the teraflop to petaflop range, and above (a ‘flop’ is a floating point operation, typically measured as the number of flops per second).

One use of processor modules is in a data center or data centers that comprise a computing cloud (collectively a ‘hosted compute resource’, or HCR, facility), where multiple modules are configured to execute user workloads. An engineering control problem of an HCR is to efficiently assign user processing requests to the compute modules to ensure low latency response times. Indeed, many HCR operators will commit to a service level that requires each request to be executed within a certain minimum period of time after submission.

Typically, a service level agreement (SLA) specifies a requirement to initiate execution of a user's processing request (i.e., a ‘workload request’) when received at the HCR within a specified period of time. The SLA can specify the minimum latency (e.g., wait time) that the request can wait in a queue before it is assigned to an available module. To meet the SLA requirements, many HCR operators will over-provision the number of modules so there will always be sufficient resources to respond in a timely manner to an unknown number of requests over any given time frame. Over-provisioning refers to the practice of maintaining more compute resources in a ready state to handle requests within the time constraints of a server agreement. Over-provisioning is, unfortunately, very expensive and costly to the environment because of wasted energy that must be expended to maintain un-used resources in the ready and powered-on state.

In the situation where there are relatively few workload requests and abundant compute resources, it is a relatively simple and quick process to assign a new workload request to an idle compute resource. However, as the number of workloads increases, a problem is created, that is, of enabling a process for finding available compute resources that does not take a lot of time to execute, and that succeeds in fulfilling SLA latency requirements.

What is needed is a process to efficiently assign compute-intensive workload requests to compute resources in a timely manner.

### SUMMARY

This Summary, together with any Claims, is a brief set of signifiers for at least one ECIN (which can be a discovery, see 35 USC 100(a); and see 35 USC 100(/)), for use in commerce for which the Specification and Drawings satisfy 35 USC 112.

In one ECIN, compute modules comprise a computer processor-based system, an accelerator processor, and/or a programmable circuit such as an FPGA, all configured to process instructions to perform useful work. In other ECINs combinations, two or more of such modules process instructions collaboratively to perform useful work when programmed by a user's algorithm

In another ECIN, a ‘friendly’ cuckoo hash algorithm is used to assign each workload request to an appropriately configured compute resource. As used herein, the signifier ‘friendly’ indicates a cuckoo hash implementation that avoids evictions in favor of finding an unoccupied compute resource module for hosting a new workload request.

In one more ECIN, when a first workload request is received, the workload is assigned to the compute resource module that has been pre-configured to execute that workload. Subsequent requests for a similar workload are assigned to a second pre-configured compute resource.

This Summary does not completely signify any ECIN. While this Summary can signify at least one essential element of an ECIN enabled by the Specification and Figures, the Summary does not signify any limitation in the scope of any ECIN.

### BRIEF DESCRIPTION OF THE DRAWINGS

The following Detailed Description, Figures, and Claims signify the uses of and progress enabled by one or more ECINs. All of the Figures are used only to provide knowledge and understanding and do not limit the scope of any ECIN Such Figures are not necessarily drawn to scale. The Figures can have the same, or similar, reference signifiers in the form of labels (such as alphanumeric symbols, e.g., reference numerals), and can signify a similar or equivalent function or use. Further, reference signifiers of the same type can be distinguished by appending to the reference label a dash and a second label that distinguishes among the similar signifiers. If only the first label is used in the Specification, its use applies to any similar component having the same label irrespective of any other reference labels. A brief list of the Figures is below.

FIG. 1 illustrates an exemplary Hosted Computer Resource (HCR) facility, in accordance with some embodiments.

FIG. 2 depicts processing of workloads by an HCR, in accordance with some embodiments.

FIG. 3 shows an exemplary HCR facility for processing workloads by an HCR, in accordance with some embodiments.

FIG. 4 is an example abstract diagram of a computer system suitable for enabling embodiments of the claimed disclosures for use in commerce, in accordance with some embodiments.

FIG. 5 is another abstract diagram of a computer system suitable for enabling embodiments of the claimed disclosures for use in commerce, in accordance with some embodiments.

FIG. 6 illustrates an example tensor streaming processor (TSP) architecture, in accordance with some embodiments.

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

### DETAILED DESCRIPTION

The Figures and Detailed Description, only to provide knowledge and understanding, signify at least one ECIN To minimize the length of the Detailed Description, while various features, structures or characteristics can be described together in a single embodiment, they also can be used in other embodiments without being written about.

Variations of any of these elements, and modules, processes, machines, systems, manufactures or compositions disclosed by such embodiments and/or examples are easily used in commerce. The Figures and Detailed Description signify, implicitly or explicitly, advantages and improvements of at least one ECIN for use in commerce.

In the Figures and Detailed Description, numerous specific details can be described to enable at least one ECIN. Any embodiment disclosed herein signifies a tangible form of a claimed invention. To not diminish the significance of the embodiments and/or examples in this Detailed Description, some elements that are known to a skilled person can be combined together for presentation and for illustration purposes and not be specified in detail. To not diminish the significance of these embodiments and/or examples, some well-known processes, machines, systems, manufactures or compositions are not written about in detail.

However, a skilled person can use these embodiments and/or examples in commerce without these specific details or their equivalents. Thus, the Detailed Description focuses on enabling the inventive elements of any ECIN Where this Detailed Description refers to some elements in the singular tense, more than one element can be depicted in the Figures and like elements are labeled with like numerals.

Handling large workloads in a (cloud-based) data center that can run petabyte-scale data analytics requires configuration, management, optimization, and security to be processed automatically. In one ECIN, support is provided for assigning and running applications on a cluster of processors that makes it easier for developers to run open-source distributed event streaming software managers, such as Apache Kafka, without manually handling capacity management. Instead, these needs are handled via automation of provisioning and scaling compute and storage resources to more accurately control the data that is streamed and retained.

Because configuration of the compute resource in an HCR comprises a significant portion of time required to initiate execution of the workload request, it is often desirable to configure one or more of the compute resource modules with the user's algorithm before the workload is assigned to a module.

Accordingly, in one ECIN, when a first workload request is received, the workload is assigned to the compute resource module that has been pre-configured to execute that workload and a subsequent request for the same workload is assigned to a second pre-configured compute resource.

As used herein, a unit of time for configuring a compute resource module is represented by a variable, Tconfig, that typically varies from several tens of microseconds to several tens of seconds. However, in some cases, configuring the compute resource modules can happen in an order of magnitude of time that is significantly faster (on the order of tens of nanoseconds for small workload requests) to being significantly longer (i.e., several seconds for larger models and massive amounts of data). Clearly, it is a challenge to assign each workload to available compute resource modules in a manner that meets SLA requirements.

With minimal compute resources, assignment of a workload request to an available compute resource is relatively straightforward. However, as the number of compute resources increases such that several thousands of such compute resources are available, the assignment process can take a significant amount of time.

Accordingly, in one ECIN, a friendly cuckoo hash algorithm is used to assign each workload request to an appropriately configured compute resource. To increase efficiency, some compute resource modules, which are initially configured for workloads that do not have stringent SLA requirements, are reconfigured for a workload that has a more stringent SLA. Accordingly, in another ECIN, the friendly cuckoo hash of the present disclosure is referred to as a friendly reconfigurable cuckoo hash wherein compute modules assigned to less stringent SLA workloads are pre-emptively re-configured with a workload where capacity achieves full utilization.

Specifically, in one ECIN, an HCR is configured with compute modules for one or more user workloads. By way of example, a workload comprises an artificial intelligence model that includes certain algorithms to perform a selected inference such as, by way of example, BERT, RESNET50 or some other such AI model. For each workload, at least two compute resource modules are configured so that the algorithm executes immediately upon receipt of a workload request without incurring the over-head cost of configuring a compute resource module with the algorithm. Configuring includes loading instructions and weights for artificial neural networks such that upon receipt of data, an inference can be run. The HCR typically comprises a plurality of compute resource modules each of which is configured for a one of a plurality of workloads. Each workload is characterized by execution time. Each compute resource module also includes a queue such that subsequent workload requests are queued for execution at the configured compute resource module. When that queue is sufficiently full such that SLA latency requirements are likely to be violated, the compute resource module is denoted as occupied and no new requests are appended to the queue. Subsequent workload requests are assigned to the second configured compute resource module.

A data structure for a workload request comprises a first data element indicating the owner of the request (RO—Request Owner), a second data element that indicates the artificial intelligence or machine learning (or other application) model to be executed, and a third data element that specifies performance requirements so that the results of the request are returned in a period of time allowed with the specification of the SLA.

In one ECIN, the elements of the data structure for a workload request are hashed to determine a computer resource module that can process the request and is available to be assigned to the RO. For example, an RO requests via the terms of the SLA for either a single instance or a plurality of compute resource modules to be fully configured with their model or models. These compute resource modules are fully configured with the selected models such that the modules are enabled and ready to execute upon request. Once the compute resource module (or modules) is configured with the model or models, the next step in the assignment determines if any of the compute resource modules include the necessary AI model specified in the workload request. To do this the data element for the AI/ML model is hashed, and the assignment table entry corresponding to the hash value is inspected to determine if the available compute module or compute modules having the appropriate model is/are ready to execute.

Once the appropriate compute module is identified, parameters are used to determine whether the queue for the selected compute module will enable compliance with SLA requirements. In instances where currently executing workloads prevent a job from being processed in accordance with the SLA requirements, additional (that is, one to several) compute modules are configured and added to the pool of compute resources available to be assigned to the RO.

Bidirectional Encoder Representations from Transformers (BERT) is a family of masked-language models introduced in 2018 by researchers at Google. A 2020 literature survey concluded that “in a little over a year, BERT has become a ubiquitous baseline in Natural Language Processing (NLP) experiments counting over 150 research publications analyzing and improving the model.”

BERT was originally implemented in the English language at two model sizes: (1) BERT_{BASE}: 12 encoders with 12 bidirectional self-attention heads totaling 110 million parameters, and (2) BERT_{LARGE}: 24 encoders with 16 bidirectional self-attention heads totaling 340 million parameters. Both models were pre-trained on the Toronto BookCorpus (800M words) and English Wikipedia (2,500M words).

To illustrate the above embodiment, consider a first workload request, e.g., a RO wishes to execute a BERT inference process. Once the request is received at the HCR, the request is hashed on an inbound server to identify in an assignment table a compute resource module that has been configured with the BERT algorithm for that particular RO.

If the first compute resource is identified as fully occupied, assignment of the request to the occupied compute resource module likely fails the SLA requirements.

Accordingly, the inbound server performs a second hash to identify a second compute module preconfigured with the BERT algorithm. If the second compute module can execute the workload within the SLA parameters, the workload request is assigned to be executed on the second compute module.

In a preferred embodiment, there are I00's to I000's of compute resource modules in the HCR. For this number of resources, the preferred hash is a 2-way Cuckoo hash. The 2-way Cuckoo hash is more effective if the available compute resource modules are less than 50% occupied. The advantage of the 2-way Cuckoo hash is that each workload only needs to be resident on two compute modules in order to ensure that each workload request will be serviced within a constant time period, and that execution of the request will complete within the time frame specified in the SLA.

If the HCR is more fully loaded, it is preferred that the hash process uses a 3-way Cuckoo hash. As the number of workload requests increase and the HCR facility is more fully loaded, that is more than about 50% of the compute modules are fully occupied, the use of the 3-way Cuckoo hash is preferred. The implication is that for each algorithm, at least three compute elements will be pre-configured with the requested algorithm.

When a collision occurs, that is, a new request cannot be assigned to the first compute module, the new request is re-hashed to find an alternative compute module rather than evicting the resident algorithm. If the second hash fails, then the new request is rehashed a third time. If the third compute module is also fully occupied, in one ECIN, the new request is assigned to the first available compute module using Horton tables as an extension of the cuckoo hash tables.

The transition from using a 2-way cuckoo hash to a 3-way cuckoo hash occurs during a checkpoint period. During the checkpoint period, a workload can be evicted from its current compute resource module and reassigned to a new location if there is a conflict between the hashes. When that occurs, the new compute resource module is selected, the algorithm is first transferred and once configured, the data from the current compute resource is transferred to the new compute resource module. If a workload is reassigned to a new compute resource module, the Horton pool resources, if any, will be transferred to the new compute resource module.

In one ECIN, the HCR pre-configures a certain number of compute resource modules for a first algorithm to be ready to be assigned incoming workload requests. These compute resource modules are grouped in the first bucket. As workload requests are received, each request is hashed and assigned to the first available compute resource module in the first bucket. The workload requests are then run/executed, and the results sent back to the Request Owner. The process repeats as new workload requests are received.

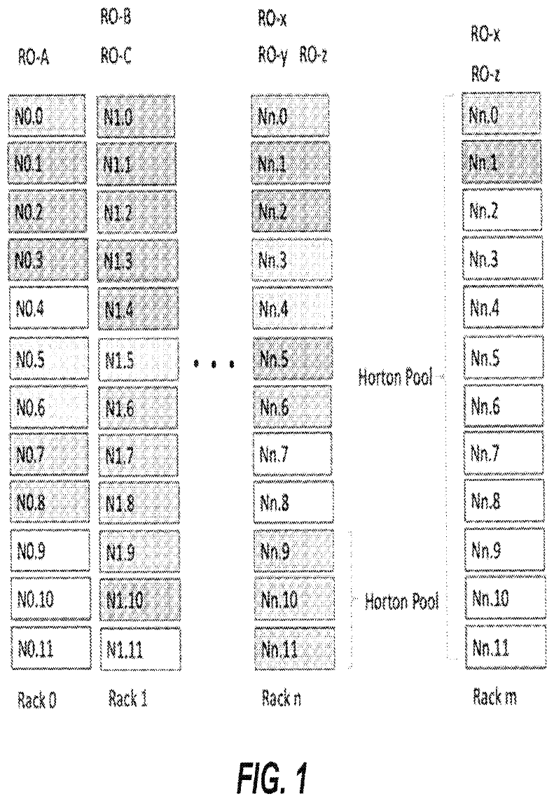

FIG. 1 illustrates an exemplary HCR where the compute resource modules comprise n racks and each rack comprises, for example, 12 nodes. In one preferred embodiment, each node comprises neural network accelerator processing units (NNAPUs) together with an optional server module, workload queues, and one or more external memory modules such as High Bandwidth Memory (HBM) modules. Each node comprises, in one ECIN, eight (8) cores (not shown) which are described more fully in a pending patent application, Ser. No. 17/203,214 filed Mar. 16, 2021, incorporated herein by reference in its entirety. The cores in one or more nodes are configured either individually to execute one or, in some embodiments, a plurality of workloads, or configured as two or more cores working collaboratively to execute a single workload. Rack m is a spare rack that serves as a part of Horton pool resources.

As illustrated in FIG. 1, nodes in the HCR are either configured with a workload as indicated by the color of the nodes or not configured (i.e., a cold node) as indicated by a lack of coloration. For example, the light blue node is configured with a first workload, while the light green nodes are each configured with a second workload. Similarly, yellow nodes are configured with a third workload as indicated by the yellow color.

In one ECIN, each rack is assigned to a particular RO or to a plurality of ROs. A portion of the nodes in each rack, (e.g., nodes 9-11) or additional racks (e.g., rack m) are not configured and are referred to as ‘cold nodes’ that can be configured at a later point in time based on user demand as part of the Horton pools. Each of the configured nodes are configured based on the requirements specified in a corresponding SLA for each of the plurality of ROs.

To illustrate, RO-A has configured five nodes in Rack O with a plurality of workloads that require, pursuant to an SLA, a minimum number of compute resource modules. By way of example, in Rack 0, nodes 5 and 6 are configured for RO-A's workload, indicated by a yellow color, which may be a NLP, LSTM, BERT or other AI workloads. Nodes 2 and 3 (gray) and nodes 7 and 8 (red) are configured for two additional workloads. Similarly, nodes 0 (green) and I (blue) in Rack O are configured for executing two additional AI models of RO-A's workloads. Because of SLA requirements, the workload at node 5 may be an active node and node 6 may be a ‘hot’ node ready to host additional workloads should additional jobs be submitted. The workloads at nodes 2 and 3 (gray workload) may both be active or may be configured but not processing a job. As indicated, node 4 is a “cold” node as it is not configured. Should additional gray or yellow workloads arrive, node 4 may be either assigned a gray workload or a yellow workload. If additional blue or green workloads are submitted, one of the nodes in the Horton pool would be configured as it is preferred that similar workloads are assigned to contiguous nodes or a Horton pool.

The location of each workload on a node is calculated by a cuckoo hash, using the RO-A and workload type as the hash key. If the first node for a workload is unavailable, a second hash function is executed to identify a possible core in a second node. If neither of the nodes are available, a linked list to a node or nodes in a Horton pool is identified and the additional workloads are then assigned to that node in the Horton pool.

In yet another ECIN, the HCR institutes checkpoints to rebalance assignment of the compute resource modules in view of the then current workflow. Specifically, the HCR has information that specifies the length of time required to execute each of the workloads. The HCR also has information on the pending requests in each of the pending request queues. Using this information, the HCR can pre-configure spare compute resource modules and add those machines to the Horton pool associated with each algorithm.

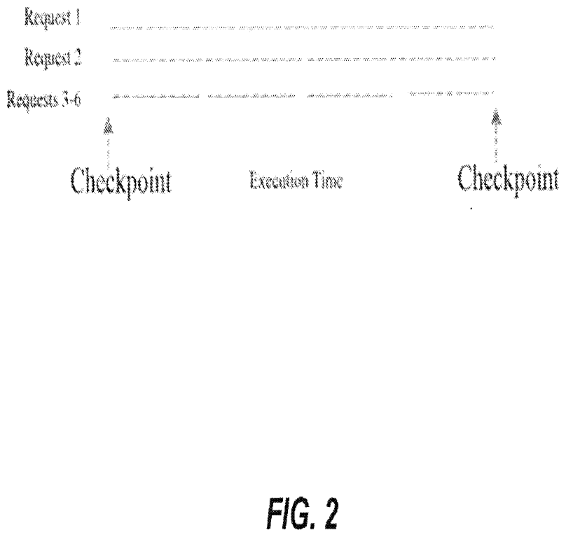

In FIG. 2 there are three algorithms, each of which has an execution time. As illustrated, the top algorithm has an execution time of, by way of example, 100,000 milliseconds (ms). The middle algorithm has an execution time of about 50,000 milliseconds so it can execute two workload requests between consecutive checkpoints. The bottom algorithm has an execution time of about 25,000 milliseconds so it can execute four workload requests between consecutive checkpoints. Requests to run one of the workloads are queued at a compute resource and will run when one of the currently executing algorithm runs to completion. As long as the last request in the queue is able to be run and complete (i.e., return a result) within the SLA timeframe, the workloads configured on the compute resource modules are in balance with respect to the number of workload requests.

However, if a new workload request, the top algorithm by way of example, is received, the queue is full, and the request needs to be rehashed to find a second available resource. If that second resource is also occupied, the request will default to the first available compute resource module from the Horton pool. In contrast, if a new request for, e.g., the bottom algorithm, it is more likely that it will be able to find an available compute resource module as a result of either the first or second hash. Accordingly, the HCR can limit the size of the Horton pool associated with the bottom algorithm and increase the size of the Horton pool associated with the top algorithm.

An HCR, in one ECIN, is a physical building housing data center infrastructure and a plurality of GroqRacks. In one example, the HCR comprises 1,000 GroqRacks configured to execute a plurality of different workload requests.

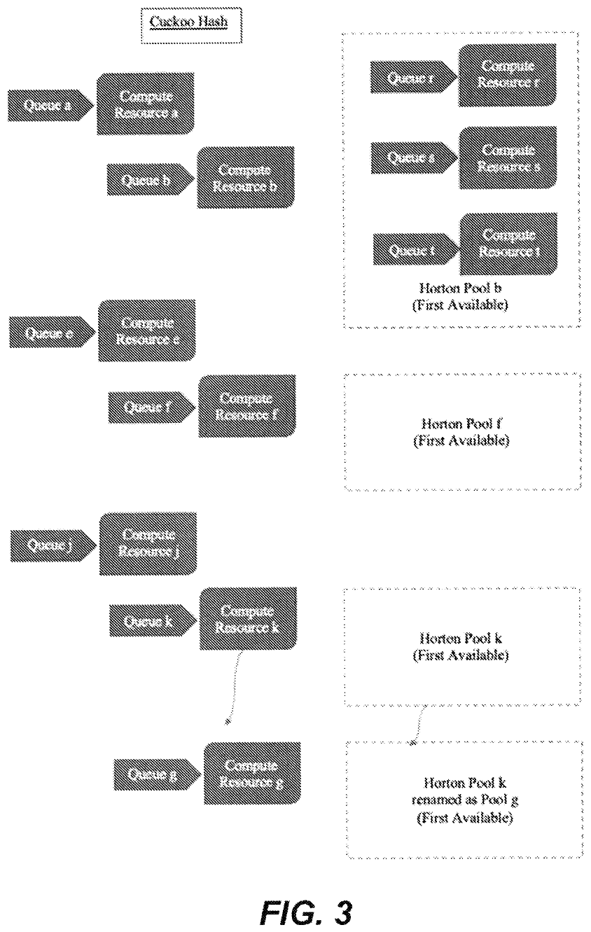

FIG. 3 illustrates an exemplary HCR facility for processing workloads by an HCR, in accordance with some embodiments. In one ECIN, if a workload is very expensive and has a variable number of users (i.e., requests) during an upcoming checkpoint period, the HCR can proactively change the quality of the result, and dynamically minimize the length of execution and time and increase the number of workload requests that can remain pending in the queue.

For example, consider a natural language processing (NLP) algorithm that predicts the next word or words in a sentence based on the previous 400 words. The HCR can determine if the algorithm, using the previous 200 words, is more efficient than using 400 words and results in a higher quality prediction.

Because the HRC uses a deterministic compiler, it can calculate the quality of the word prediction result, to make sure the algorithm always returns the QPS/IPS required by the SLA rather than merely run the original algorithm, where QPS means Queries Per Second and IPS means Instructions Per Second. Accordingly, the HRC includes an SLA-based programming interface that proactively advises the RO that the algorithm has predicted a quality of result at a shorter execution time to make sure the RO-Always gets the QPS/IPS needed without having to provision additional compute resource modules for the applicable Horton pool (e.g., see FIG. 3).

In this ECIN, the SLA advises that if the RO specifies a limit of 200 current words (or in the general context, “items”) in the queue then there is a first price per item and a first result quality of result but if there are more than 200 items but less than 400 items then there is a second price per item and a second result quality and so on up to a maximum number of items.

The RO can then select the result quality that allows the highest quality at a selected price OR a minimum result quality at a flat rate. The pricing advantage arises because where the SLA reduces the number of items to be executed, the execution time for the workloads is shortened for each instance and fewer modules need to be included in the respective Horton pool. This level of RO control enables SLA based adjustment of the execution time and matches HRC resources with workload demand.

To illustrate, a RO requests to limit the cost to maintain an additional compute resource module in the Horton pool. In this instance, the first and second pre-configured compute resource module which can provide inferences for up to five workload requests during a checkpoint period and subsequent requests are assigned to a compute resource module in the associated Horton pool. If during a period of high demand, ten workload requests are received, the SLA can specify that the execution time be adjusted to allocate the execution time to the I 0 requests without moving the request to a Horton pool module. Thus, in instances where there are no more than five requests, the HRC can provide max quality for each such request. In instances where the number of requests doubles to ten, the HRC can adjust the execution time for each request to provide half quality results within the SLA required time frame without moving the additional requests to a new compute resource module in the Horton pool (e.g., see FIG. 3).

Because the HRC can calculate the execution time and QoR, the RO can determine how workloads are allocated to compute resource elements to satisfy their need for quality and in view of their financial constraints. Prior art data centers can queue the requests but are unable to calculate the actual Qualitative Operational Requirement(QoR) dynamically, relying instead on approximating the QoR and/or over- provision the compute resource modules.

In yet another embodiment, the HCR provides a level of service specified in a QoS document or SLA using compute resource modules that are partially defective. As used herein, ‘partially defective’ signifies that the module is only used in certain applications. For example, the module can have timing issues at high frequency and high case temperatures, so it is only used in situations where it is operated at a lower operating frequency. In other instances, a section of SRAM is defective, so the device has to avoid storing data in that section. In such instances, smaller algorithms execute using the sections that are still functional.

In one ECIN such partially defective devices are assigned to a Horton pool where the defect will not significantly impact SLA or QoR commitments to the RO.

In operation, the HCR maintains a resource availability map identifying the characterized defect. The resource map is then loaded into a compiler associated with each workload request. The compiler is further configured to evaluate the workload and select only those partially defective modules capable of providing sufficient resources to execute the workload and to meet the specified QoS or SLA requirements. The resource map comprises a list of each deployed module and the configuration that will be matched by the compiler for each algorithm. In a preferred embodiment, the resource map comprises a defect classification identifying the defect associated and a list of available resources. The resource map also comprises a QoS designation.

The HCR compiler evaluates the resource requirements for each workload algorithm and selects one or more of the partially defective modules. When the module is pre-configured, the algorithm is compiled to use only the available resources. In some embodiments, the defects may be a determination that the compute resource modules are too hot to run at high clock rates. In such instances, the HCR compiler can cause a workload algorithm to run at a lower clock rate or at a lower voltage or both lower clock rate and lower voltage.

Although in one ECIN, the modules are deployed in a cloud it is also possible to deploy such modules “on premise” in a rack or on a card in a desktop or edge application.

In yet another ECIN, there is a repository of pre-compiled models in a server-less cloud data center acting as a “compile” service, for which a RO uploads, for example, an ONNX file, calls a “compile” function that will produce a binary executable, and places it in a repository visible by the Groq nodes. Then, that RO or another RO executes a “mn” function on that model through the service APL Thus, “build a model” and “execute a model”, are separate workflows.

In yet another ECIN, a real-time orchestration service is used to manage all of the running models or computer modules in the data center. During compilation of a model or module, the compiler determines the number of processor cycles and power needed to complete the individual computational request. The orchestration services ensure that incoming computational requests can be added to the currently executing models while not exceeding the total capabilities of the data center, and while not exceeding the requirements of an SLA. The orchestration service can either delay processing of the ne\v request, or slow down existing requests that have lower priorities, or query the owner of the incoming request if a lower accuracy model can be used.

### DETAILED DESCRIPTION—TECHNOLOGY SUPPORT FROM DATA/INSTRUCTIONS TO PROCESSORS/PROGRAMS

Data and Information. While ‘data’ and ‘information ’ often are used interchangeably (e.g., ‘data processing’ and ‘information processing’), the term ‘datum’ (plural ‘data’) typically signifies a representation of the value of a fact (e.g., the measurement of a physical quantity such as the current in a wire, or the price of gold), or the answer to a question (e.g., ‘yes” or “no”), while the term ‘information’ typically signifies a set of data with structure (often signified by ‘data structure’). A data structure is used in commerce to transform an electronic device for use as a specific machine as an article of manufacture (see In re Lowry, 32 F.3d 1579 [CAFC, 1994}). Data and information are physical objects, for example binary data (a ‘bit’, usually signified with ‘O’ and ‘I’) enabled with two levels of voltage in a digital circuit or electronic component. For example, data can be enabled as an electrical, magnetic, optical or acoustical signal or state; a quantum state such as a particle spin that enables a ‘qubit’; or a physical state of an atom or molecule. All such data and information, when enabled, are stored, accessed, transferred, combined, compared, or otherwise acted upon, actions that require and dissipate energy. As used herein, the term ‘process’ signifies an artificial finite ordered set of physical actions (‘action’ also signified by ‘operation’ or ‘step’) to produce at least one result. Some types of actions include transformation and transportation. An action is a technical application of one or more natural laws of science or artificial laws of technology. An action often changes the physical state of a machine, of structures of data and information, or of a composition of matter. Two or more actions can occur at about the same time, or one action can occur before or after another action, if the process produces the same result. A description of the physical actions and/or transformations that comprise a process are often signified with a set of gerund phrases (or their semantic equivalents) that are typically preceded with the signifier ‘the steps of’ (e.g., “a process comprising the steps of measuring, transforming, partitioning and then distributing . . . ”). The signifiers ‘algorithm’, ‘method’, ‘procedure’, ‘(sub)routine’, ‘protocol’, ‘recipe’, and ‘technique’ often are used interchangeably with ‘process’, and 35 USC. JOO defines a “method” as one type of process that is, by statutory law, always patentable under 35 USC101. As used herein, the term ‘thread’ signifies a subset of an entire process. A process can be partitioned into multiple threads that can be used at or about at the same time.

As used herein, the term ‘rule’ signifies a process with at least one logical test (signified, e.g., by ‘IF test IS TRUE THEN DO process’).). As used herein, ‘grammar’ is a set of rules for determining the structure of information. Many forms of knowledge, learning, skills and styles are authored, structured, and enabled—objectively—as processes and/or rules—e.g., knowledge and learning as functions in knowledge programming languages.

As used herein, the term ‘component’ (also signified by ‘part’, and typically signified by ‘element’ when described in a patent text or diagram) signifies a physical object that is used to enable a process in combination with other components. For example, electronic components are used in processes that affect the physical state of one or more electromagnetic or quantum particles/waves (e.g., electrons, photons) or quasiparticles (e.g., electron holes, phonons, magnetic domains) and their associated fields or signals. Electronic components have at least two connection points which are attached to conductive components, typically a conductive wire or line, or an optical fiber, with one conductive component end attached to the component and the other end attached to another component, typically as part of a circuit with current or photon flows. There are at least three types of electrical components: passive, active and electromechanical. Passive electronic components typically do not introduce energy into a circuit- such components include resistors, memristors, capacitors, magnetic inductors, crystals, Josephson junctions, transducers, sensors, antennas, waveguides, etc. Active electronic components require a source of energy and can inject energy into a circuit - such components include semiconductors (e.g., diodes, transistors, optoelectronic devices), vacuum tubes, batteries, power supplies, displays (e.g., LEDs, LCDs, lamps, CRTs, plasma displays).

Electromechanical components affect current flow using mechanical forces and structures. Such components include switches, relays, protection devices (e.g., fuses, circuit breakers), heat sinks, fans, cables, wires, terminals, connectors and printed circuit boards.

As used herein, the term ‘netlist’ is a specification of components comprising an electric circuit, and electrical connections between the components. The programming language for the SPICE circuit simulation program is often used to specify a netlist. In the context of circuit design, the term ‘instance’ signifies each time a component is specified in a netlist.

One of the most important components as goods in commerce is the integrated circuit, and its res of abstractions. As used herein, the term ‘integrated circuit’ signifies a set of connected electronic components on a small substrate (thus the use of the signifier ‘chip’) of semiconductor material, such as silicon or gallium arsenide, with components fabricated on one or more layers. Other signifiers for ‘integrated circuit’ include ‘monolithic integrated circuit’, ‘IC’, ‘chip’, ‘microchip’ and ‘System on Chip’ (‘SoC’). Examples of types of integrated circuits include gate/logic arrays, processors, memories, interface chips, power controllers, and operational amplifiers. The term ‘cell’ as used in electronic circuit design signifies a specification of one or more components, for example, a set of transistors that are connected to function as a logic gate. Cells are usually stored in a database, to be accessed by circuit designers and design processes.

As used herein, the term ‘module’ signifies a tangible structure for acting on data and information. For example, the term ‘module’ can signify a process that transforms data and information, for example, a process comprising a computer program (defined below). The term ‘module’ also can signify one or more interconnected electronic components, such as digital logic devices. A process comprising a module, if specified in a programming language (defined below), such as System C or Verilog, also can be transformed into a specification for a structure of electronic components that transform data and information that produce the same result as the process. This last sentence follows from a modified Church-Turing thesis, which is simply expressed as “Whatever can be transformed by a (patentable) process and a processor, can be transformed by a (patentable) equivalent set of modules.”, as opposed to the doublethink of deleting only one of the “(patentable)”.

A module is permanently structured (e.g., circuits with unalterable connections), temporarily structured (e.g., circuits or processes that are alterable with sets of data), or a combination of the two forms of structuring. Permanently structured modules can be manufactured, for example, using Application Specific Integrated Circuits (‘ASICs’) such as Arithmetic Logic Units (‘ALUs’), Programmable Logic Arrays (‘PLAs’), or Read Only Memories (‘ROMs’), all of which are typically structured during manufacturing. For example, a permanently structured module can comprise an integrated circuit. Temporarily structured modules can be manufactured, for example, using Field Programmable Gate Arrays (FPGAs—for example, sold by Xilink or Intel's Altera), Random Access Memories (RAMs) or microprocessors. For example, data and information is transformed using data as an address in RAM or ROM memory that stores output data and information. One can embed temporarily structured modules in permanently structured modules (for example, a FPGA embedded into an ASIC).

Modules that are temporarily structured can be structured during multiple time periods. For example, a processor comprising one or more modules has its modules first structured by a manufacturer at a factory and then further structured by a user when used in commerce. The processor can comprise a set of one or more modules during a first time period, and then be restructured to comprise a different set of one or modules during a second time period The decision to manufacture or implement a module in a permanently structured form, in a temporarily structured form, or in a combination of the two forms, depends on issues of commerce such as cost, time considerations, resource constraints, tariffs, maintenance needs, national intellectual property laws, and/or specific design goals. How a module is used, its function, is mostly independent of the physical form in which it is manufactured or enabled. This last sentence also follows from the modified Church-Turing thesis.

As used herein, the term ‘processor’ signifies a tangible data and information processing machine for use in commerce that physically transforms, transfers, and/or transmits data and information, using at least one process. A processor consists of one or more modules, e.g., a central processing unit (‘CPU’) module; an input/output (‘1/0’) module, a memory control module, a network control module, and/or other modules. The term ‘processor’ can also signify one or more processors, or one or more processors with multiple computational cores/CPUs, specialized processors (for example, graphics processors or signal processors), and their combinations. Where two or more processors interact, one or more of the processors can be remotely located relative to the position of the other processors. Where the term ‘processor’ is used in another context, such as a ‘chemical processor’, it will be signified and defined in that context.

The processor can comprise, for example, digital logic circuitry (for example, a binary logic gate), and/or analog circuitry (for example, an operational amplifier). The processor also can use optical signal processing, DNA transformations, quantum operations, microfluidic logic processing, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, also can transform data and information. No scientific evidence exists that any of these technological processors are processing, storing and retrieving data and information, using any process or structure equivalent to the bioelectric structures and processes of the human brain. The one or more processors also can use a process in a ‘cloud computing’ or ‘timesharing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specified network interfaces (‘interface’ defined below) (e.g., an application program interface (‘API’) that signifies functions and data structures to communicate with the remote process).

As used herein, the term ‘computer’ and ‘computer system’ (further defined below) includes at least one processor that, for example, performs operations on data and information such as (but not limited to) the Boolean logical operations using electronic gates that can comprise transistors, with the addition of memory (for example, memory structured with flip- flops using the NOT-AND or NOT-OR operation). Any processor that can perform the logical AND, OR and NOT operations (or their equivalent) is Turing-complete and computationally universal [FACT}. A computer can comprise a simple structure, for example, comprising a 110 module, a CFU module, and a memory that performs, for example, the process of inputting a signal, transforming the signal, and outputting the signal with no human intervention.

As used herein, the term ‘programming language’ signifies a structured grammar for specifying sets of operations and data for use by modules, processors and computers. Programming languages include assembler instructions, instruction- set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, Javascript, FHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3DIVRML, or MIDI), and any future equivalent programming languages. As used herein, the term ‘source code’ signifies a set of instructions and data specified in text form using a programming language. A large amount of source code for use in enabling any of the claimed inventions is available on the Internet, such as from a source code library such as Github.

As used herein, the term ‘program’ (also referred to as an ‘application program’) signifies one or more processes and data structures that structure a module, processor or computer to be used as a “specific machine” (see In re Alappat, 33 F3d 1526 [CAFC, 1991}). One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program and is typically not very accessible to or modifiable by the user of a computer. Computer programs and firmware are often specified using source code written in a programming language, such as C. Modules, circuits, processors, programs and computers can be specified at multiple levels of abstraction, for example, using the SystemC programming language, and have value as products in commerce as taxable goods under the Uniform Commercial Code (see UC. C. Article 2, Part 1). A program is transferred into one or more memories of the computer or computer system from a data and information device or storage system. A computer system typically has a device for reading storage media that is used to transfer the program, and/or has an interface device that receives the program over a network. This transfer is discussed in the General Computer Explanation section.

### DETAILED DESCRIPTION—TECHNOLOGY SUPPORT

### General Computer Explanation

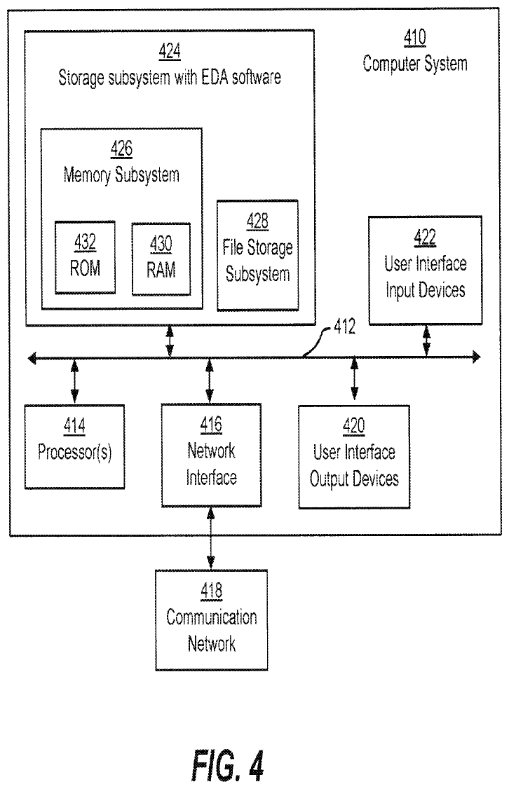

FIG. 4 is an example abstract diagram of a computer system suitable for enabling embodiments of the claimed disclosures, in accordance with some embodiments. In some embodiments described herein, a host processor may comprise the computer system of FIG. 4.

In FIG. 4, the structure of computer system 410 typically includes at least one computer 414 which communicates with peripheral devices via bus subsystem 412. Typically, the computer includes a processor (e.g., a microprocessor, graphics processing unit, or digital signal processor), or its electronic processing equivalents, such as an Application Specific Integrated Circuit (ASIC) or Field Programmable Gate Array (FPGA). Typically, peripheral devices include a storage subsystem 424, comprising a memory subsystem 426 and a file storage subsystem 428, user interface input devices 422, user interface output devices 420, and/or a network interface subsystem 416. The input and output devices enable direct and remote user interaction with computer system 410. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor.

A computer system typically is structured, in part, with at least one operating system program, for example, MICROSOFT WINDOWS, APPLE MACOS and IOS, GOOGLE ANDROID, Linux and/or Unix. The computer system typically includes a Basic Input/Output System (BIOS) and processor firmware. The operating system, BIOS and firmware are used by the processor to structure and control any subsystems and interfaces connected to the processor. Example processors that enable these operating systems include: the Pentium, Itanium, and Xeon processors from INTEL; the Opteron and Athlon processors from AMD (ADVANCED MICRO DEVICES); the Graviton processor from AMAZON; the POWER processor from IBM; the SPARC processor from ORACLE; and the ARM processor from ARM Holdings.

Any embodiment of the present disclosure is limited neither to an electronic digital logic computer structured with programs nor to an electronically programmable device. For example, the claimed embodiments can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of computer system 410 depicted in FIG. 4 is intended only as an example. Many other structures of computer system 410 have components than the computer system depicted in FIG. 4.

Network interface subsystem 416 provides an interface to outside networks, including an interface to communication network 418, and is coupled via communication network 418 to corresponding interface devices in other computer systems or machines. Communication network 418 can comprise many interconnected computer systems, machines and physical communication connections (signified by ‘links’). These communication links can be wireline links, optical links, wireless links (e.g., using the Wi-Fi or Bluetooth protocols), or any other physical devices for communication of information. Communication network 418 can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or Integrated Services Digital Network (ISDN)), (asynchronous) digital subscriber line (DSL) unit, Firewire interface, universal serial bus (USB) interface, and the like. Communication algorithms (‘protocols’) can be specified using one or communication languages, such as Hypertext Transfer Protocol (HTTP), Transmission Control Protocol/Internet Protocol (TCP/IP), Real-time Transport Protocol/Real Time Streaming Protocol (RTP/RTSP), Internetwork Packet Exchange (IPX) protocol and/or User Datagram Protocol (UDP).

User interface input devices 422 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into computer system 410 or onto communication network 418. User interface input devices typically enable a user to select objects, icons, text and the like that appear on some types of user interface output devices, for example, a display subsystem.

User interface output devices 420 can include a display subsystem, a printer, a fax machine, or a non-visual communication device such as audio and haptic devices. The display subsystem can include a CRT, a flat-panel device such as an LCD, an image projection device, or some other device for creating visible stimuli such as a virtual reality system. The display subsystem also can provide non-visual stimuli such as via audio output, aroma generation, or tactile/haptic output (e.g., vibrations and forces) devices. Typically, the term ‘output device’ signifies all possible types of devices and processes to transfer data and information out of computer system 410 to the user or to another machine or computer system. Such devices are connected by wire or wirelessly to a computer system. Note that some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits, which use any of the above input or output devices.

Memory subsystem 426 typically includes several memories including a main RAM 430 (or other volatile storage device) for storage of instructions and data during program execution and a ROM 432 in which fixed instructions are stored. File storage subsystem 428 provides persistent storage for program and data files, and can include a hard disk drive, a floppy disk drive along with associated removable media, a CD-ROM drive, an optical drive, a flash memory such as a USB drive, or removable media cartridges. If computer system 410 includes an input device that performs optical character recognition, then text and symbols printed on a physical object (such as paper) that can be used as a device for storage of program and data files. The databases and modules used by some embodiments can be stored by file storage subsystem 428.

Bus subsystem 412 provides a device for transmitting data and information between the various components and subsystems of computer system 410. Although bus subsystem 412 is depicted as a single bus, alternative embodiments of the bus subsystem can use multiple buses. For example, a main memory using RAM can communicate directly with file storage systems using DMA systems.

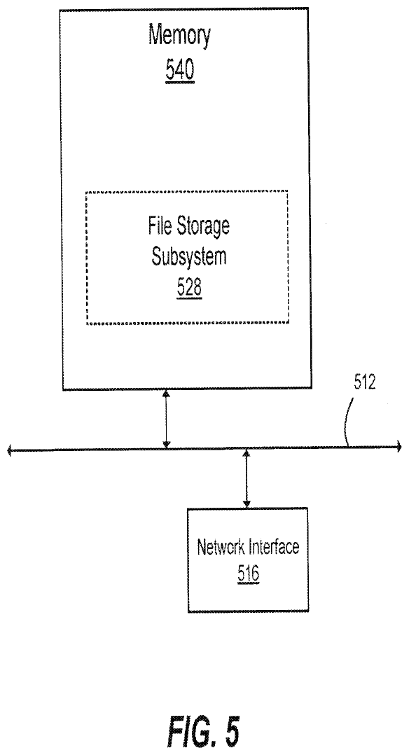

FIG. 5 is another abstract diagram of a computer system suitable for enabling embodiments of the claimed disclosures, in accordance with some embodiments. In some embodiments described herein, a host processor may comprise the computer system of FIG. 5.

FIG. 5 depicts a memory 540 such as a non-transitory, processor readable data and information storage medium associated with file storage subsystem 528, and/or with network interface subsystem 516 (e.g., via bus subsystem 512), and can include a data structure specifying a circuit design. The memory 540 can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program transferred in to and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light).

One skilled in the art will recognize that any of the computer systems illustrated in FIGS. 4-5 comprises a machine for performing a process that achieves an intended result by managing work performed by controlled electron movement.

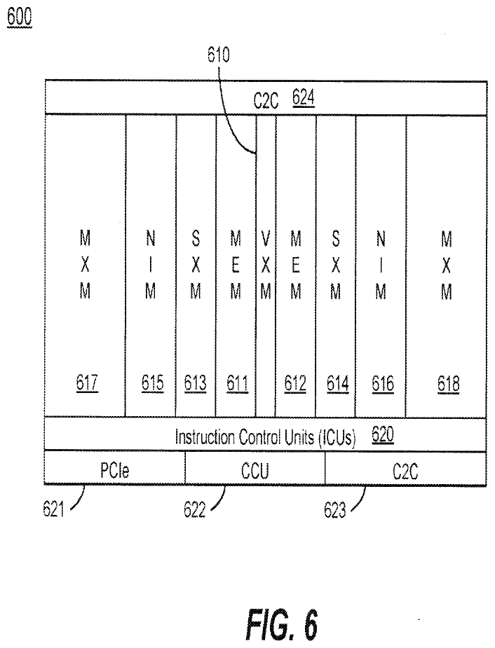

FIG. 6 illustrates an example architecture of TSP 600, in accordance with some embodiments. The TSP 600 (e.g., an AI processor and/or ML processor) includes memory and arithmetic modules (or functional slices) optimized for multiplying and adding input data with weight sets (e.g., trained or being trained) for AI and/or ML applications (e.g., training or inference). Each functional slice in the TSP 600 performs any of a variety of functions under the control of instructions transferred from instruction memory buffers in instruction control units (ICUs) 620. These functions include memory storage and retrieval for data in a superlane, integer arithmetic, floating point arithmetic, transferring data between superlanes, some other function, or combination thereof.

As shown in FIG. 6, the TSP 600 includes a vector multiplication module (VXM) 610 for performing multiplication operations on vectors (i.e., one-dimensional arrays of values). For example, the VXM 610 includes 16 vector ALUs per lane arranged in groups of four ALUs. In one embodiment, the VXM 610 comprises 5,120 ALUs having 32-bit wide operands arranged in 16 lanes and 16 slices (organized in four ranks of four rows) replicated across a plurality of 20 superlanes. Other elements of the TSP 600 are arranged symmetrically to optimize processing speed. As illustrated in FIG. 6, the VXM 610 is directly adjacent to memory modules (i.e., MEM) 611, 612. For example, each MEM 611, 612 includes 44 functional slices comprising static random-access memory (SRAM). Switch matrix units (i.e., SXM functional slices or inter-lane switches) 613 and 614 are further symmetrically arranged to control routing of data within (e.g., to perform a transpose) or between superlanes. The TSP 600 further includes numerical interpretation modules (i.e., NIM functional slices) 615 and 616 for numeric conversion operations, and matrix multiplication units (i.e., MXM functional slices) 617 and 618 for matrix multiplications. For example, MEM functional slices perform Read and Write operations but not Add or Mul, which are only performed in the VXM and MXM functional slices. In some embodiments, MXM functional slices and NIM functional slices are combined, and may include, by way of example, 320×320 matrix units. ICUs 620 control execution of operations across all functional slices 610-618. The TSP 600 may further include communications circuits such as chip-to-chip (C2C) circuits 623, 624 that function to couple multiple TSP devices into a single processor core, and an external communication circuit (e.g., 621.) The TSP 600 may further include a chip control unit (CCU) 622 to control, e.g., boot operations, clock resets, some other low-level setup operations, or some combination thereof.

The TSP 600 may support different application programming interface (API) packages. One API package employed by the TSP 600 is an instruction API, which can be based on, e.g., Python functions that provide a conformable instruction-level TSP programming interface. Another API employed by the TSP 600 is a tensor API, which represents a high-level application interface that supports components and tensors rather than individual instructions streaming across the TSP 600 at particular time periods (e.g., clock cycles or compute cycles). A composite API supported by the TSP 600 represents an API that includes both the instruction API and the tensor API.

### DETAILED DESCRIPTION—SEMANTIC SUPPORT

The signifier ‘commercial solution’ signifies, solely for the following paragraph, a technology domain-specific (and thus non-preemptive—see Bilski): electronic structure, process for a specified machine, manufacturable circuit (and its Church-Turing equivalents), or a composition of matter that applies science and/or technology for use in commerce to solve an unmet need of technology.

The signifier ‘abstract’ (when used in a patent claim for any enabled embodiments disclosed herein for a new commercial solution that is a scientific use of one or more laws of nature {see Benson}, and that solves a problem of technology {see Diehr} for use in commerce—or improves upon an existing solution used in commerce {see Diehr})—is precisely defined by the inventor(s) {see MPEP 2111.01 (9th edition, Rev. 08.2017)} as follows: a) a new commercial solution is ‘abstract’ if it is not novel (e.g., it is so well known in equal prior art {see Alice} and/or the use of equivalent prior art solutions is long prevalent {see Bilski} in science, engineering or commerce), and thus unpatentable under 35 USC 102, for example, because it is ‘difficult to understand’ {see Merriam-Webster definition for ‘abstract’} how the commercial solution differs from equivalent prior art solutions; or b) a new commercial solution is ‘abstract’ if the existing prior art includes at least one analogous prior art solution {see KSR}, or the existing prior art includes at least two prior art publications that can be combined {see Alice} by a skilled person {often referred to as a ‘PHOSITA’, see MPEP 2141-2144 (9th edition, Rev. 08.2017)} to be equivalent to the new commercial solution, and is thus unpatentable under 35 USC. 103, for example, because it is ‘difficult to understand’ how the new commercial solution differs from a PHOSITA—combination/-application of the existing prior art; or c) a new commercial solution is ‘abstract’ if it is not disclosed with a description that enables its praxis, either because insufficient guidance exists in the description, or because only a generic implementation is described {see Mayo} with unspecified components, parameters or functionality, so that a PHOSITA is unable to instantiate an embodiment of the new solution for use in commerce, without, for example, requiring special programming {see Katz} (or, e.g., circuit design) to be performed by the PHOSITA, and is thus unpatentable under 35 USC. 112, for example, because it is ‘difficult to understand’ how to use in commerce any embodiment of the new commercial solution.

### DETAILED DESCRIPTION—CONCLUSION

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof solve any problems disclosed herein, and without limitation to the scope of the Claims of the patent. When an ECIN comprises a particular feature, structure, function or characteristic, it is within the knowledge and understanding of a skilled person to use such feature, structure, function, or characteristic in connection with another ECIN whether or not explicitly described, for example, as a substitute for another feature, structure, function or characteristic.

In view of the Detailed Description, a skilled person will understand that many variations of any ECIN can be enabled, such as function and structure of elements, described herein while being as useful as the ECIN One or more elements of an ECIN can be substituted for one or more elements in another ECIN, as will be understood by a skilled person. Writings about any ECIN signify its use in commerce, thereby enabling other skilled people to similarly use this ECIN in commerce.

This Detailed Description is fitly written to provide knowledge and understanding. It is neither exhaustive nor limiting of the precise structures described but is to be accorded the widest scope consistent with the disclosed principles and features. Without limitation, any and all equivalents described, signified or Incorporated by Reference (or explicitly incorporated) in this patent application are specifically incorporated into the Detailed Description. In addition, any and all variations described, signified or incorporated with respect to any one ECIN also can be included with any other ECIN Any such variations include both currently known variations as well as future variations, for example any element used for enablement includes a future equivalent element that provides the same function, regardless of the structure of the future equivalent element.

It is intended that the domain of the set of claimed inventions and their embodiments be defined and judged by the following Claims and their equivalents. The Detailed Description includes the following Claims, with each Claim standing on its own as a separate claimed invention. Any ECIN can have more structure and features than are explicitly specified in the Claims.

What is claimed is:

1. A method to efficiently assign compute-intensive workload requests to compute resources in a timely manner while enabling real-time orchestration using a friendly cuckoo algorithm for provisioning hosted compute resources (HRC); said method comprising:
(A) appropriately configuring a compute resource module; and
(B) using said friendly cuckoo algorithm to selectively assign a job to an available, appropriately configured compute resource module in an efficient manner;
wherein at least one said compute resource module configured to process instructions to perform useful work further comprises a compute module selected from the group consisting of: a computer processor-based system; an accelerator processor; and a programmable circuit such as an FPGA.

2. The method of claim 1, wherein said at least one HCR provides at least one configured compute resource modules based on real-time demand.

3. The method of claim 1, wherein said at least one said HCR comprises a plurality of GroqRacks configured to execute a plurality of different workload requests.

4. The method of claim 3, wherein said at least one HRC is configured to use a deterministic compiler to calculate the quality of the word prediction result, and wherein said friendly cuckoo algorithm returns the Queries Per Second (QPS)/Instructions Per Second (IPS) required by the service level agreement (SLA).

5. The method of claim 4, wherein said at least one HCR is configured to increase the number of compute modules that are preconfigured with the appropriate AI models as the number of requests increases.

6. The method of claim 4, wherein said at least one HCR is enabled to guarantee an amount of scheduling density with a limited window of advanced notice while minimizing the likelihood of over-provisioning in anticipation of a specific workload.

7. The method of claim 4, wherein said at least one HRC includes an SLA-based programming interface that proactively advises at least one Request Owner (RO) that said friendly cuckoo algorithm has predicted a quality of result at a shorter execution time without having to provision additional compute resource modules for an applicable Horton pool.

8. The method of claim 7, wherein said at least one RO can select the result quality that allows the highest quality at a selected price.

9. The method of claim 7, wherein said at least one RO can select a minimum result quality at a flat rate, wherein said pricing advantage arises because where the SLA reduces the number of items to be executed, the execution time for the workloads is shortened for each instance and fewer modules need to be included in the respective Horton pool.

10. The method of claim 7, wherein said at least one RO determines how workloads are allocated to compute resource elements to satisfy said RO needs for quality and in view of said RO financial constraints.

11. The method of claim 7, wherein said at least HRC is configured to calculate the execution time the actual Qualitative Operational Requirement (QoR) dynamically without over-provisioning said at least one compute resource module.

12. The method of claim 7, wherein said at least HRC is configured to provide a level of service specified in said SLA using at least one partially defective compute resource module;
wherein said partially defective compute resource module is configured to be used in certain applications.

13. The method of claim 12, wherein said at least HRC is configured to provide a level of service specified in said SLA using at least one said partially defective compute resource module operational at a lower operating frequency.

14. The method of claim 12, wherein said at least HRC is configured to provide a level of service specified in said SLA using at least one said partially defective compute resource having a defective section of SRAM.

15. The method of claim 12, wherein said at least HRC is configured to provide a level of service specified in said SLA using at least one said partially defective compute module assigned to a Horton pool where said defect will not substantially impact SLA or QoR commitments to the RO.

16. The method of claim 12, wherein said at least HRC further comprises a resource availability map further comprising a list of each deployed module and the configuration that will be matched by the compiler for each algorithm.

17. The method of claim 12, wherein said at least HRC further comprises a resource availability map further comprising a defect classification identifying the defect associated and a list of available resources.

18. The method of claim 12, wherein said at least HRC further comprises a resource availability map further comprising a list of QoS designations.

19. The method of claim 12, wherein said at least HRC is configured to provide a level of service specified in said SLA using at least one said partially defective compute module., and wherein said at least one HCR maintains said resource availability map identifying the characterized defect; and wherein said resource availability map is loaded into a compiler associated with each workload request, and wherein said compiler is further configured to evaluate the workload and select only those partially defective modules capable of providing sufficient resources to execute the workload and to meet the specified QoS or SLA requirements.

20. The method of claim 12, wherein said at least HRC compiler is configured to evaluate the resource requirements for each workload algorithm and selects one or more of the partially defective modules.
